(19) United States
(12) Patent Application Publication
(10) Pub. No.: US 2023/0351069 A1
(43) Pub. Date: Nov. 2, 2023

(54) Particle-Based Mechanical Hazard Determination for a Machine Safety System

(71) Applicant: Pilz GmbH & Co. KG, Ostfildern (DE)

(72) Inventors: Daniel Frederic Stein, Ostfildern (DE); Bernd Neuschwander, Ostfildern (DE); Patrick Stehle, Ostfildern (DE)

(21) Appl. No.: 18/310,685

(22) Filed: May 2, 2023

(30) Foreign Application Priority Data
May 2, 2022 (DE) 102022110711.6

(51) Int. Cl. G06F 30/17; G05B 19/4069

(52) U.S. Cl. CPC G06F 30/17; G05B 19/4069; G05B 2219/50193

(57) ABSTRACT

A computer-implemented method for determining a parameter of a safety configuration of a safety system for a machine includes providing a virtual model of the machine in a virtual environment. The method includes simulating a scattering of particles from the virtual model of the machine and acquiring simulation data. The method includes determining spin changes of the particles, each associated with a location at the time of the spin change. The method includes filtering the determined spin changes according to a set of filter criteria. According to a first filter criterion, filtering is performed for ones of the spin changes that are greater than or equal to a defined threshold value. The method includes determining mechanical hazard locations based on the locations that are associated with the filtered spin changes. The method includes determining the parameter of the safety configuration based on the determined mechanical hazard locations.

### CROSS-REFERENCE TO RELATED APPLICATIONS

This application claims priority to German Patent Application No. 10 2022 110 711.6 filed May 2, 2022, the entire disclosure of which is incorporated by reference.

### FIELD

The present disclosure relates to a computer-implemented method for determining at least one parameter of a safety configuration of a safety system for a machine. Further, the present disclosure relates to a method for setting up a safety system for a machine.

### BACKGROUND

In the design, production and operation of machines and facilities, safety of these machines and facilities is essential. In Europe, for example, this requirement is normatively defined by the Machinery Directive (CE), which prescribes regular risk assessment for the complete service life of a machine.

For CE certification, a hazard analysis of machines must be performed according to the EN ISO 12100 standard. The EN ISO 12100 standard defines the basic terminology and methodology and establishes general guiding principles for risk assessment and risk reduction to assist designers in producing safe machines.

An important aspect of the analysis is the evaluation of mechanical hazard locations or danger locations that pose a potential hazard to humans. Mechanical hazard locations are, for example, edges or spikes, for example, sharp edges or spikes.

Such mechanical hazard locations of a machine must be determined and secured. Various technical protective measures can be taken to secure mechanical hazard locations. For example, a safety system may be provided to secure certain hazard locations on the machine. For example, the safety system may comprise sensors, cameras, edge protectors or barriers by means of which the hazard locations can be secured.

Up to now, CE certification has been carried out manually by an inspector. For example, up to now the test specimen has been analyzed manually by an inspector at his own discretion for mechanical hazard locations.

### SUMMARY

It is an object to provide a method by which safety of a machine can be improved. Furthermore, it is an object to provide a method by means of which detection and securing of hazard locations of a machine can be improved.

According to a first aspect of the present invention, this problem is solved by a computer-implemented method for determining at least one parameter of a safety configuration of a safety system for a machine, comprising the steps of:
providing a virtual model of the machine in a virtual environment;
simulating a scattering of one or more particles from the virtual model of the machine in the virtual environment, wherein simulation data of the particles is acquired during the simulation;
determining spin changes of the particles based on the simulation data, wherein each spin change is associated with a location of the corresponding particle at the time of the spin change;
filtering the determined spin changes according to one or more filter criteria, wherein according to a first filter criterion of the filter criteria, filtering is performed for the spin changes that are greater than or equal to a defined threshold value;
determining mechanical hazard locations based on the locations that are associated with the filtered spin changes;
determining the at least one parameter of the safety configuration based on the determined mechanical hazard locations.

According to a second aspect of the present invention, there is provided a method for setting up a safety system for a machine, comprising the steps of:
determining at least one parameter of a safety configuration of the safety system for the machine using the method according to the first aspect of the invention; and
setting up the safety system based on the safety configuration.

According to a third aspect of the present invention, there is provided a computer program product comprising a computer program that comprises program code means for performing a method according to the first aspect of the invention when the computer program is executed on a computer. Further, there may also be provided a computer program product comprising instructions that, when the program is executed by a computer, cause the computer to perform the steps of the method according to the first aspect of the invention.

The new method can be implemented using a processing unit or a control device, which may be a general-purpose computer or a specialized computer, wherein an appropriate computer program or computer program product is stored and executed, wherein the computer program or computer program product is designed and configured for determining the at least one parameter of the security configuration of the security system for the machine or for setting the security system for the machine according to the previously mentioned methods.

The virtual environment comprises a computer-generated, three-dimensional space, which may also be referred to as virtual space. By means of the virtual environment, objects can be modeled, textured and animated. For example, a virtual environment may be generated on a computer using appropriate software programs (for example, a graphics engine). For simulation, for example, the software Blender may be used.

In the virtual environment, a virtual model of the machine is provided or generated. The virtual model is a 3D model of the machine. For example, the virtual model may be a design model or a CAD (computer-aided design) model. A virtual model of the machine is based, for example, on 3D data of the machine, by means of which the virtual model may be generated and thus provided in the virtual environment.

In the virtual environment, the motion of objects may be simulated. In the simulation according to the proposed method, the motion of one or more particles in the virtual environment is simulated. The particles can have an expansion. For example, the particles may be spherical. The particles can also have a mass. For example, the mass may be homogeneously distributed over the volume of the particle or homogeneously distributed on the surface of the particle. The surface of the particles may comprise a surface roughness, which may also be referred to as stickiness. All particles in the simulation can have the same physical properties such as mass, size, shape and surface roughness. For example, identical particles may be used.

The virtual model of the machine can be stationary in the virtual environment. Alternatively, the virtual model of the machine may have a mass that is much greater than the mass of the particles.

For simulation, the particles are generated in the virtual environment. For movement of the particles, the virtual environment may comprise a force field, for example, a gravitational field. For example, the origin of the force field, for example, the center of gravity, may be located at the center or center of mass of the virtual model. Alternatively, the force field may also be a repulsive force field originating from a spherical shell in the center of which the virtual model is arranged. Alternatively or additionally, the particles may already be generated with a defined velocity or a defined momentum in the virtual environment, wherein the velocity vector at generation can point in the direction of the virtual model of the machine.

The particles may be scattered on the surface of the virtual model of the machine. During the scattering, the particles collide with the virtual model of the machine and are deflected as a result. The collision of the particles with the virtual model can be inelastic. For example, the virtual model and the particles in the virtual environment may be simulated as rigid bodies. The location where the particles collide with the virtual model may be referred to as scattering location.

In general, when a particle collides with an object, the momentum and angular momentum of the particle may change. For example, the direction of motion and spin of the colliding particles may change during a collision. The spin of a particle may also be referred to as intrinsic angular momentum or twist. In general, the spin of a body is a rotational motion or rotation about the center of mass of the body. Therefore, when particles are scattered from the virtual model, the direction of motion and, for example, the spin of the particles may change.

During the simulation, simulation data of the particles are acquired. At least a location and a spin of each particle at a plurality of times can be acquired as simulation data. The simulation data can be acquired at regular time intervals (for example, over the duration of the simulation). The plurality of times may therefore follow each other at equal time intervals. Each time interval corresponds thus to a simulation step. In other words, the simulation data is regularly acquired at specific time intervals over the duration of the simulation, i.e. for each simulation step. Thus, the simulation data includes the location and spin of each particle for each time (for example, for each simulation step).

The acquired simulation data is then analyzed. For example, it is determined whether the spin of the particles has changed during the simulation. A change in spin is referred to as a spin change. For example, the simulation data is analyzed to determine spin changes of the particles. To do this, the spin of a particle is considered at each of two acquired, successive times (a first time and a second time). A spin change can be present if the difference between the spin at the first time and the spin at the second time is not equal to zero. For example, the absolute value of the difference between the spin at the first time and the spin at the second time may be taken as a measure of a spin change.

Each spin change can be associated with a location of the corresponding particle at the time of the spin change. For example, the location at the time of the spin change may be the location at the first time, the location at the second time, or an average of the two locations at the two times.

As explained above, a change of a spin of a particle always occurs as a result of a collision of the particle. For example, the spin of a particle changes when the particle collides with the virtual model of the machine, i.e. is scattered by it. The location of the particle at the time of the spin change is then at the scattering location of the particle.

The determined spin changes are then filtered. One or more filter criteria are applied for filtering. In other words, filtering means searching for specific spin changes that meet the filter criteria. By filtering, those spin changes that do not meet the applied filter criteria are discarded. Thus, filtered spin changes are referred to as those spin changes that satisfy the applied filter criteria.

The one or more filter criteria comprise at least a first filter criterion. According to the first filter criterion, filtering is performed for spin changes greater than or equal to a defined threshold value. In other words, according to the first filter criterion, a threshold method is applied.

When particles are scattered at a mechanical hazard location, such as an edge or spike of the machine, there is at least an increased probability that a large or greater spin change will occur. The probability increases further the sharper or pointier the edge or spike is. Thus, for scattering at mechanical hazard locations, the spin change is usually greater than for scattering at surfaces that are relatively flat or only slightly curved. For example, for scattering at sharp edges or spikes, the spin change is usually much greater than for scattering at a relatively flat or slightly curved surface.

By filtering according to a threshold value, small spin changes are filtered out, i.e. discarded. This may discard spin changes that are not caused by scattering at mechanical hazard locations. The level of the threshold value indicates the sensitivity of the filtering. The higher the threshold value, the sharper or pointier an edge or spike of the machine must be to cause a corresponding spin change of the particle upon scattering. In other words, threshold-based filtering thus enables filtering for spin changes that occur at mechanical hazard locations.

Based on the locations associated with the filtered spin changes, mechanical hazard locations of the machine may then be determined. Mechanical hazard locations may be edges or peaks of the surface of the machine, wherein the location of these edges or peaks is determined based on the locations associated with the filtered spin changes. For example, mechanical hazard locations are sharp or pointy, i.e., safety-related, edges or peaks of the surface of the machine. By filtering according to the first filter criterion, the filtered spin changes are usually caused by scattering at mechanical hazard locations. The location associated with the spin change is then located at the respective mechanical hazard location.

Based on the determined mechanical hazard locations, at least one parameter of a safety configuration of a safety system for the machine can then be determined.

The safety system may comprise various protection devices for securing mechanical hazard locations of the machine. For example, physical protection devices such as edge protectors, barriers, markers and the like or sensory ones such as sensors, light grids, cameras and the like may be provided as protection devices. By means of a physical protection device, a mechanical hazard location may be secured by impeding or preventing access to it through appropriate arrangement of the physical protection device. By means of a sensory protection device, a mechanical hazard location may be secured by monitoring an area, i.e. a safety zone, around the mechanical hazard location by means of the sensory protection device. The area may, for example, be defined by a safety distance from the mechanical hazard point. The sensory protection devices may be connected to a control device of the safety system. If it is detected that a human enters the monitored area or is in the monitored area, appropriate protective measures may be taken. For example, the protection device or the control device of the safety system may be configured to issue a visual or audible alarm signal or to switch off the machine if it is detected that a human is entering the monitored area or is present in the monitored area.

A safety configuration of the safety system thus defines the arrangement and/or configuration of one or more protection devices of the safety system. The safety configuration is defined by one or more parameters. A parameter of the safety configuration thus determines the arrangement and/or configuration of one or more protection devices. In other words, a parameter of the safety configuration thus determines a protective measure for securing the mechanical hazard location.

According to the determined safety configuration of the safety system, the safety system may then be set up accordingly to secure the determined mechanical hazard locations of the machine. Thereby, a protective measure is implemented to prevent or impede that a human may be injured at the determined mechanical hazard locations.

If all determined spin changes are less than the threshold value, filtering by the first filter criterion will discard all determined spin changes. In this case, it is determined that there are no mechanical hazard locations. Accordingly, no protective measures are required.

The same applies if no spin changes occur in the simulation, that is, if the spin of the particles does not change during the simulation. In this case, no protective measures are required either.

The new, proposed method thus provides a method for determining mechanical hazard locations. This method may also be called particle spin method. By means of the particle spin method, mechanical hazard locations, such as sharp edges or spikes, may be detected automatically. By means of the particle spin method, CE certification may thus be performed automatically. In addition, it is possible to perform the analysis of the mechanical hazard locations only on the basis of the design data of the machine, for example the CAD data. Compared to a manual CE certification, the proposed method offers the advantage that the determination may be performed quickly, reliably and, for example, at an early time in the development process (for example, based on a CAD design model).

Further, in the proposed method, appropriate protective or securing measures are determined based on the determined hazard locations. Therefore, in the proposed method, at least one parameter of the safety configuration of the safety system is determined based on the determined hazardous locations. The safety system may then be set up according to the determined safety configuration to secure the machine. In this way, the safety of the machine is improved. For example, the new proposed method improves the detection and securing of hazard locations of a machine.

The problem posed above is thus solved in its entirety.

In a first refinement, the number of particles may be greater than 1000, greater than 10,000 or 30,000, or greater than 100,000.

For example, the number of particles may be between 10,000 and 30,000. The particles can be randomly or arbitrarily distributed in the virtual space around the virtual model at the beginning of the simulation. In this way, a better scanning of the body of the virtual model of the machine is obtained with a relatively low simulation time. A lower number of particles can be compensated with a longer simulation time to obtain a high scanning even with few points.

In a further refinement, the particles may comprise a particle size of 1 mm to 1000 mm, 5 mm to 600 mm, or 50 mm.

The particle size defines a diameter (for example, a maximum expansion) of the particles. A smaller particle size achieves finer scanning of the body of the virtual model of the machine. But a particle size that is too small may result in scanning areas of the body of the virtual model of the machine that are not accessible to a human. Therefore, the particle size can be set to correspond to dimensions of the human body, such as those of an arm, hand, or finger. For example, the particle size may be 50 to 100 cm (roughly corresponding to an average arm length) or 10 cm to 30 cm (roughly corresponding to an average hand length) or 5 cm to 10 cm (roughly corresponding to a finger length) or 1 cm to 2 cm (roughly corresponding to a finger thickness). In this way, it can be simulated whether a human may reach an area, i.e. whether an area is accessible to a human being. By selecting a suitable particle size, it may be ensured that only those mechanical hazard locations are detected that are accessible to a human.

In a further refinement, for simulating the scattering a certain number of the particles may be scattered simultaneously at the virtual model of the machine, for example, wherein the particles can collide with each other during the simulation of the scattering.

In general, for simulating the scattering, the particles may be scattered either individually, i.e. one after the other and independently of each other, or simultaneously on the model. In case of simultaneous scattering, the particles may collide with each other during simulating the scattering. Colliding means that the particles may collide with each other and thus change their direction of motion. This allows areas of the body of the virtual model of the machine to be reached that would be difficult or impossible to reach without collisions between the particles. In this way, the scanning of the body of the virtual model of the machine is further improved.

In a further refinement, for simulating the scattering, the particles, for example, the certain number of particles, may be emitted inwardly from a sphere (for example, from the sphere inward), wherein the sphere is arranged in the virtual environment so that it surrounds the virtual model of the machine.

The sphere can be a closed surface, for example, a spherical surface, and serves as the area in which the particles are generated for simulation. This sphere may therefore be referred to as an emission sphere. The emission locations from which the particles are emitted by the sphere may be either randomly distributed or substantially uniformly distributed on the sphere. The virtual model can be located at the center of the emission sphere. Upon generation on the emission sphere, the particles may have a velocity, i.e. an initial momentum. The direction of this velocity may be inward (especially in the normal direction to the sphere). The particles can be emitted without initial spin. By emitting from such a sphere, a relatively uniform scanning of the body of the virtual model of the machine is achieved.

Further, in the virtual environment, i.e. in the virtual space, there may also be arranged a further sphere, which may be referred to as a reflection sphere. The reflection sphere also surrounds the virtual model, wherein the virtual model can be arranged in the center. The reflection sphere is at least as great as or greater than the emission sphere. The reflection sphere is stationary in the virtual environment. Particles that collide with the reflection sphere coming from the inside are reflected back to the inside. In this way, the particles are kept in a defined spatial volume in the virtual environment during the simulation. In this way, the frequency of collisions of the particles with the body of the virtual model of the machine is increased during the simulation. Thereby, the scanning of the body of the virtual model of the machine is also improved.

In a further refinement, in the step of filtering according to a second filter criterion of the filter criteria, filtering may be performed for the spin changes whose associated locations in the virtual environment are within a vicinity of the virtual model (i.e. at or near the virtual model).

Filtering according to the second filter criterion can be performed before filtering according to the first filter criterion. Alternatively, filtering according to the first filter criterion may be performed before filtering according to the second filter criterion. In a further alternative, filtering according to the first and second filter criteria may also be performed simultaneously. “At or near the virtual model” thus defines a certain area around the virtual model, wherein in filtering according to the second filter criterion, the spin changes are filtered out whose associated locations are not in the certain area around the virtual model. For example, the certain area may be defined by a certain distance to the center of mass or the center of the virtual model, wherein the certain distance is at least as great as a diameter or a maximum expansion of the virtual model. By means of the certain distance, a sphere is thus defined in which the virtual model is arranged. The virtual model can be located in the sphere and may be smaller than the emission sphere. Alternatively, the certain area may also be defined by a certain distance to the surface of the virtual model. Thus, by filtering according to the second filter criterion, spin changes are discarded that are not caused by collisions of the particles with the body of the virtual model of the machine. In other words, collisions of the particles with other objects, for example of the particles with each other or with the outer reflection sphere, are thereby filtered out.

In a further refinement, in the step of determining the spin changes, a spin map may be generated based on the determined spin changes and the locations associated therewith, wherein the spin map is filtered in the step of filtering, wherein in the step of determining the mechanical hazard locations of the machine, the mechanical hazard locations are determined based on the filtered spin map.

The spin map represents the spin changes at the associated locations. For example, the location may be described by coordinates x, y, z of a Cartesian coordinate system. The spin map is thus an association of the determined spin changes S(x, y, z) with the corresponding locations. In other words, the spin map contains all determined spin changes. In the filtering step, the spin map is filtered. This is done by discarding those spin changes from the spin map that do not satisfy the applied filtering criteria. Thus, the filtered spin map contains only those spin changes that satisfy the applied filter criteria. The filtered spin map may also be referred to as a thinned spin map. Thus, the filtered spin map contains only the locations where large spin changes occur, especially in the area of the machine, which can be attributed to mechanical hazard locations.

In a further refinement, the at least one parameter of the safety configuration may be an arrangement and/or configuration of a protection device of the safety system and/or an arrangement of a safety zone around the determined mechanical hazard locations and/or a safety distance from the determined mechanical hazard locations.

An arrangement of a protection device can define the location, orientation, shape and/or size of the protection device. As protection devices, the physical and sensory protection devices already explained above may be used. A configuration of a protection device defines how the protection device is set up to protect the corresponding hazard locations. For example, a sensory protection device may be configured to monitor an area defined by the safety distance or the safety zone. A safety zone or safety distance define an area that a person should not or may not enter or reach. This area is therefore an area to be monitored or secured. The monitoring or securing may be done by means of the corresponding protection devices of the safety system. The safety configuration defined by means of the parameters is then used to configure the safety system accordingly. In other words, the safety configuration is used to set up the protection devices according to the safety configuration. The arrangement and/or configuration of a protection device and the determination of a safety zone and/or a safety distance are thus used to secured the determined mechanical hazard locations.

In a further refinement, in setting up the safety system, a protection device of the safety system may be arranged and/or configured based on the safety configuration.

By this, the protection device is arranged and configured such that it can secured or monitor at least one corresponding hazard location of the machine. For example, a sensory protection device may be configured such that it monitors an area to be monitored around the hazard location. A physical protection device may be configured and arranged such that it secures the hazard location, i.e. impedes or prevents access to the hazard location by a human. In this way, the securing of the machine is implemented accordingly.

In a further refinement, in setting up the safety system, a safety zone or a safety distance may be set based on the safety configuration, wherein the safety zone or the safety distance is monitored or protected by means of a protection device of the safety system.

For example, a sensory protection device may be provided that is configured to monitor the safety zone or the safety distance. Further, a physical protection device may also be provided that is configured to secure the safety zone or the safety distance. For example, the safety configuration may also define a plurality of safety zones or safety distances for a plurality of hazard locations, wherein either one or more sensory protection devices are set up (i.e. arranged and configured accordingly) to monitor the safety zones and/or safety distances from mechanical hazard locations. In this way, the securing of the machine is implemented accordingly.

It goes without saying that the features mentioned above and those to be explained below can be used not only in the combination indicated in each case, but also in other combinations or on their own, without leaving the scope of the present invention.

### BRIEF DESCRIPTION OF THE DRAWINGS

Embodiments of the invention are shown in the drawings and are explained in more detail in the following description.

FIG. 1 shows a schematic view of a machine and a safety system for securing the machine.

FIGS. 2A and 2B show two example views of arrangements of a protection device for the securing or monitoring of a hazard location.

FIG. 3 shows a schematic illustration of an embodiment of a method for determining at least one parameter of a safety configuration of a safety system for a machine.

FIG. 4 shows a schematic illustration of an embodiment of a method for setting a safety system for a machine.

FIG. 5 shows an example illustration of a collision of a ball with a plane surface.

FIG. 6 shows an example illustration of a collision of a ball with a curved surface.

FIG. 7 shows an example illustration of a simulation of the scattering of particles on a test body.

FIG. 8 shows an illustration of a spin map of the simulation from FIG. 7.

FIG. 9 shows an example illustration of a simulation of the scattering of particles on a machine.

FIG. 10 shows an illustration of a filtered spin map of the simulation from FIG. 9.

FIG. 11 shows an illustration of a more filtered spin map of the simulation from FIG. 9.

### DETAILED DESCRIPTION

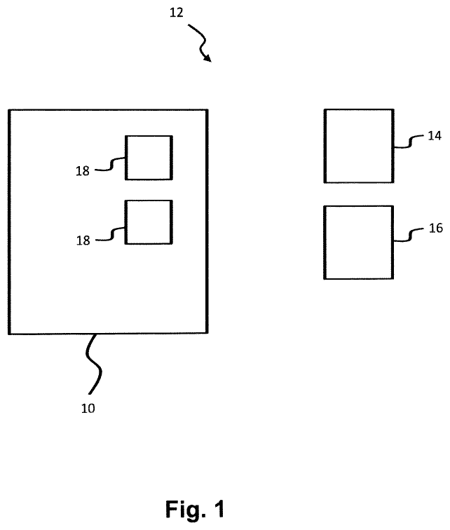

FIG. 1 shows a machine 10 and a safety system 12. The machine 10 comprises mechanical hazard locations 18, such as sharp edges or spikes. The safety system 12 serves to safeguard/protect the machine 10, for example, to secure the mechanical hazard locations 18. The safety system 12 comprises one or more protection devices 14, 16. The protection devices 14, 16 may be physical protection devices 14 (for example barriers, edge protectors, markers, etc.) and/or sensory protection devices 16 (for example sensors, cameras, etc.). By means of the protection devices 14, 16, the mechanical hazard locations 18 may be secured.

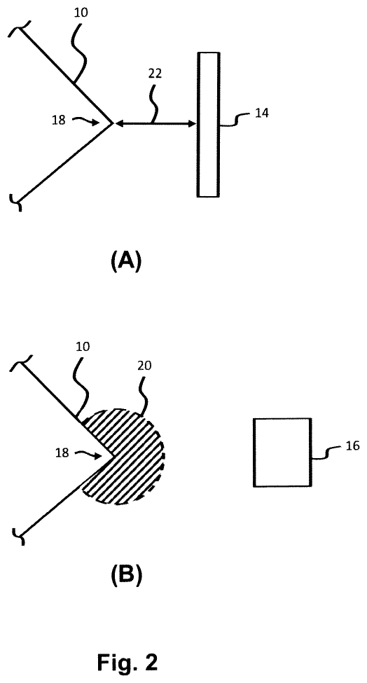

FIGS. 2A and 2B show two examples of securing a mechanical hazard location 18 by means of a protection device 14, 16. These examples serve as examples of a safety configuration of the safety system 12. The safety configuration defines an arrangement and/or configuration of protection devices 14, 16 of the safety system 12.

In the first example (FIG. 2A), a physical protection device 14—for example a barrier—is arranged at a certain safety distance 22 from a mechanical hazard location 18 of the machine 10. The physical protective device 14 impedes or prevents access to the mechanical hazard location 18.

In the second example (FIG. 2B), a sensory protection device 16—for example a camera or an optical sensor—is arranged such that it monitors a safety zone 20 around a mechanical hazard location 18 of the machine 10. The sensory protection device 16 is configured to detect when a human enters the safety zone 20 and/or is present in the safety zone 20. If the sensory protection device 16 detects this, an alarm may be triggered, for example.

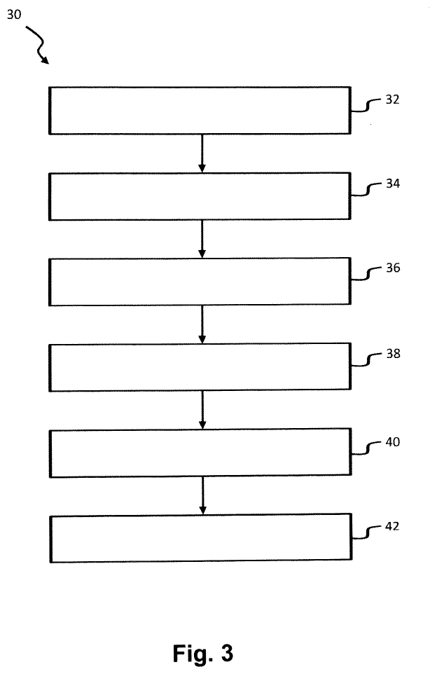

FIG. 3 shows an embodiment of a method 30 for determining at least one parameter of a safety configuration of the safety system 12 for the machine 10. The method 30 may be performed in a computer-based manner. For example, the steps of the method 30 may be performed using a computer. Therefore, the method 30 is a computer-implemented method.

In a first step 32 of method 30, a virtual model of the machine 10 is provided in a virtual environment.

In a further step 34 of the method 30, a scattering of one or more particles from the virtual model of the machine 10 is simulated in the virtual environment, wherein simulation data of the particles are acquired during the simulation. As simulation data, a location and a spin of each particle may be acquired at a plurality of successive times over the duration of the simulation.

The number of particles can be greater than 1000, greater than 10,000 or 30,000, or greater than 100,000. The particles can comprise a particle size of 1 mm to 1000 mm, 5 mm to 600 mm, or 50 mm.

To simulate the scattering, a certain number of the particles may be scattered simultaneously on the virtual model of the machine, for example, wherein the particles may collide with each other during simulating the scattering.

Further, to simulate the scattering, the particles, for example, the certain number of particles, may be emitted inwardly from an emission sphere, wherein the emission sphere is arranged in the virtual environment such that it surrounds the virtual model of the machine 10. Additionally, a reflection sphere may also be provided in the virtual environment, which can surround the emission sphere. During the simulation, the reflection sphere reflects the particles, which collide with the reflection sphere from the inside, back to the inside.

In a further step 36 of the method 30, spin changes of the particles are determined based on the simulation data, wherein each determined spin change is associated with a location of the corresponding particle at the time of the spin change. For example, a spin map may be generated based on the determined spin changes and the associated locations.

In a further step 38 of the method 30, the determined spin changes are filtered according to one or more filter criteria. According to a first filter criterion of the filter criteria, filtering may be performed for spin changes that are greater than or equal to a defined threshold value. According to a second filter criterion of the filter criteria, filtering may be performed for spin changes whose associated locations in the virtual environment are at or near the virtual model. For example, in the step of filtering 38, the spin map may be filtered.

In a further step 40 of method 30, mechanical hazard locations are determined based on the locations associated with the filtered spin changes. For example, mechanical hazard locations may be determined based on the filtered spin map.

In a further step 42 of method 30, the at least one parameter of the safety configuration is determined based on the determined mechanical hazard locations. For example, a plurality of the safety configuration may also be determined based on the determined mechanical hazard locations. The at least one parameter of the safety configuration defines an arrangement and/or configuration of a protection device 14, 16 of the safety system 12 and/or an arrangement of a safety zone 20 around the determined mechanical hazard locations and/or a safety distance 22 from the determined mechanical hazard locations.

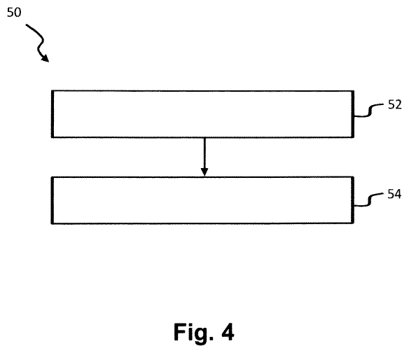

FIG. 4 shows an embodiment of the new method 50 for setting up the safety system 12 for the machine 10.

In a first step 52 of the method 50, at least one parameter of a safety configuration of the safety system 12 for the machine 10 is determined. The determination of the at least one parameter of the safety configuration of the safety system 12 for the machine 10 may be performed using the method 30 of FIG. 3.

In a further step 54 of the method 50, the safety system 12 is set up based on the safety configuration that is defined by means of the at least one, determined parameter. In setting up the security system 12, a protection device 14, 16 of the security system 12 may be arranged and/or configured based on the security configuration. Further, in setting up the safety system 12, a safety zone 20 or a safety distance 22 may be set up based on the safety configuration, wherein the safety zone 20 or the safety distance 22 is monitored or secured by means of a protection device 14, 16 of the safety system 12.

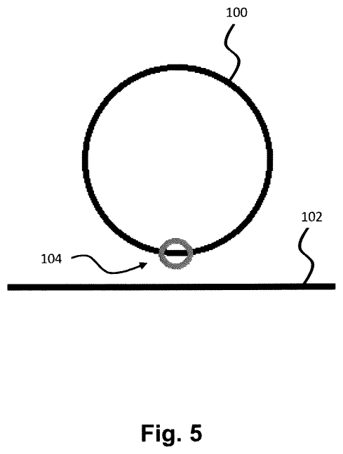

FIGS. 5 to 8 describe the operation of the particle spin method on which the new method is based.

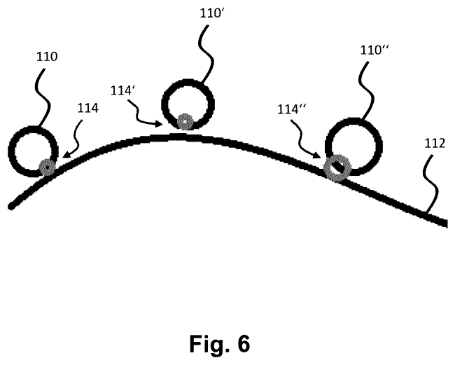

First of all, two thought experiments are considered in FIGS. 5 and 6. One is in an idealized environment (gravity present) but no damping is considered (concretely: no friction, no air resistance).

First, in FIG. 5, a collision of a ball 100 (a sphere) with a flat surface 102 (a flat floor) is considered. One is in a room, with a flat floor. Now, a ball is dropped straight down without spin. The ball will now return to where it was dropped. In this process, the ball will hit the ground with the frontmost point in the direction of flight first. This point may be called the point of impact and is designated by the reference sign 104 in FIG. 5. With this collision, the ball does not get any spin or twist after the collision.

Second, in FIG. 6, a collision of a ball 110 (a sphere) with a curved surface 112 (an undulating floor) is considered. For example, in FIG. 5, the same experiment as in FIG. 5 is repeated, but now with an undulating floor instead of a flat floor. Now the case occurs that the ball 110 no longer hits with the foremost point in the direction of flight, but with an arbitrary other point 114, which is located on the lower half of the ball 110, 110′, 110″. For better illustration, this is shown in FIG. 6 with several balls 110, 110′, 110″ which come into contact with the curved surface 112 at different impact points 114, 114′, 114″ during impact.

The particle spin method makes use of this characteristic, especially for edges it is statistically more likely that a particle does not hit straight and thus gets a spin. For example, the sharper the edge or spike of the body with which the particle collides, the greater is the resulting spin change.

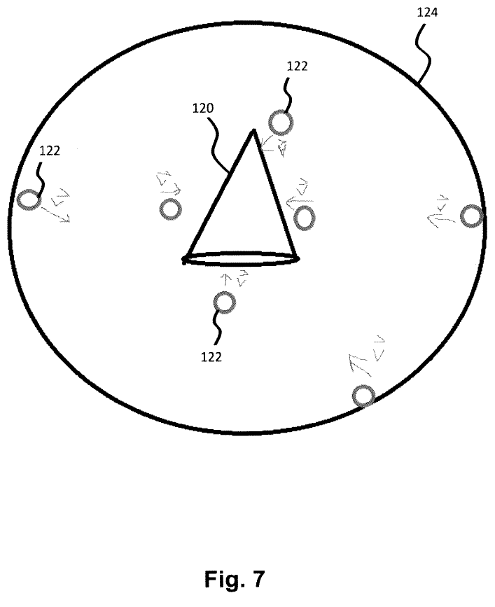

In FIG. 7, the particle spin method is demonstrated using an example of a test body 120 that comprises a conical shape. For example, the test body 120 is a cone. In the particle spin method, particles 122 are scattered from the test body 120, and spin changes of the particles during the scattering are analyzed.

For this purpose, a virtual environment, i.e. a simulation environment, is initially provided. The virtual environment may be generated, for example, by means of a graphics engine. For example, the computer program Blender may be used for this purpose to generate the virtual environment as well as objects in this virtual environment and to simulate their movement. The virtual environment provides a three-dimensional virtual space, which may be described using Cartesian coordinates, for example.

In the virtual environment, a model of the test body 120 is initially generated or provided. The center of mass or the center of the test body 120 can be arranged in the origin of the virtual environment. In the virtual environment, an emission sphere 124 is then arranged around the test body (for example, around the origin of the virtual environment). Additionally, a reflection sphere may be arranged around the test body, which is at least as great as the emission sphere 124 and surrounds or coincides with the emission sphere 124.

An attractive force field (gravitational field) may be generated or simulated at the center or center of mass of the test body 120 or at the origin of the virtual environment. Alternatively, an external repulsive force field may be generated that is located on either the emission sphere or the reflection sphere or surrounds both spheres. By means of the force field, the particles 122 are accelerated towards the test body 120.

At the start of the simulation, the particles 122 are generated on the emission sphere 124. The generation locations are randomly distributed or uniformly distributed over the entire emission sphere 124. The number of particles may be, for example, 10,000 to 30,000. The particle size may be, for example, 5 cm. The appropriate particle number may vary greatly depending on the complexity of the test body. The particles can be round and can have a mass. Further, the particles have a surface roughness, which may also be called stickiness.

To simulate the scattering, the movement of the particles is simulated after their generation, for example in discrete simulation steps. Each simulation step corresponds to a time interval. The simulation steps may also be referred to as time steps. Each simulation step may thus be associated with a time during the simulation. The simulation can comprise at least 1,000 simulation steps. For each simulation step (i.e. for each time), at least the location (e.g. three variables) and the spin (e.g. three or four variables) of each particle are acquired as simulation data. For example, the simulation data are acquired for the entire duration of the simulation (i.e. for all simulation steps). The acquired simulation data can be stored during the simulation. The stored simulation data is then available for further analysis (for example, for determining the spin changes and the mechanical hazard locations).

The particles can be emitted from the surface of the emission sphere inwardly, for example, in the normal direction to the surface, at a certain velocity during their generation. During the simulation, the particles 122 can collide with each other as well as with the virtual model of the test body 120 as well as with the reflection sphere 124. In this process, the particles do not collide with their center of mass/center, but with their outer shell/surface. In this way, the surface of the test body 120 is scanned with the particles during the simulation. When scattering at the test body, the particles can change their spin.

Based on the simulation data acquired during the simulation, it can then be determined if and when the spin of a particle changed during the simulation and if so, how great the spin change is. In this way, all spin changes of the particles that occurred during the simulation are determined. A spin map may then be generated based on the determined spin changes.

Next, the spin changes or the spin map are filtered. On the one hand, it may be filtered for spin changes that occurred in a certain, limited area around the test body (i.e. at or near the test body). Spin changes that are not caused by a collision with the test body are filtered out. Further, it may be filtered for spin changes that or whose absolute values are greater than a certain threshold value. In this way, small spin changes that are not caused by collisions with edges or spikes can be filtered out.

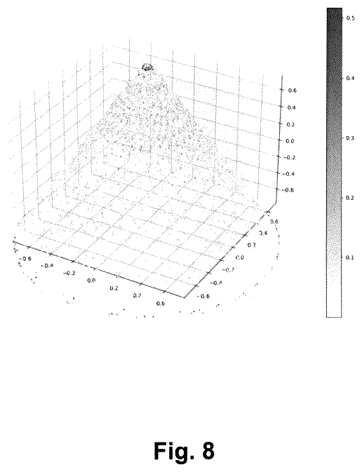

In FIG. 8, a spin map with spin changes on the surface of the test body (cone) from the simulation in FIG. 7 is shown. The spin map may also be referred to as a “spin heat map”. For example, in the spin map of FIG. 8, it can be seen that the spike as well as the bottom edge of the cone comprise higher spin changes than the rest of the cone. The location of a high spin change thus corresponds (at least with high probability) to the location of a spike or edge, i.e. a mechanical hazard location, of the test body. If the threshold value for filtering is increased accordingly, only spin changes at the spike and at the lower edge of the cone remain.

As described above, the spin map is used to analyze the spin change of the particles between two times. The particles all have random flight directions and also collide with each other. The idea of a frictionless ball pool, where each ball has a velocity, is very appropriate. In this method, the particle size is also freely adjustable, so one may also specify whether a particle is large enough to reach a certain location. In other words, the particle size may be adapted to the dimensions of parts of the human body (e.g. arm, hand, finger). Thus, indirectly, one also makes a reachability analysis by looking at the locations where spin changes occur and those where they do not.

Based on the filtered spin map, the location of mechanical hazard locations such as edges and spikes may thus be determined. For example, the locations of the filtered spin changes correspond to the location of mechanical hazard locations of the machine.

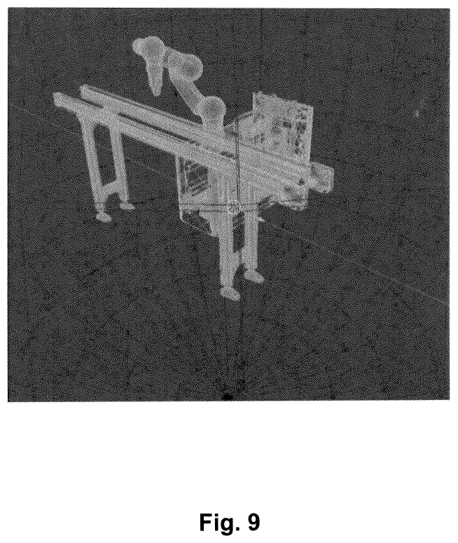

In FIGS. 9-11, example simulation of the scattering of particles from a machine is shown. In FIG. 9, a model of the machine is arranged in a virtual environment. In this example, the machine comprises a conveyor belt and a robotic arm adjacent to a conveyor belt.

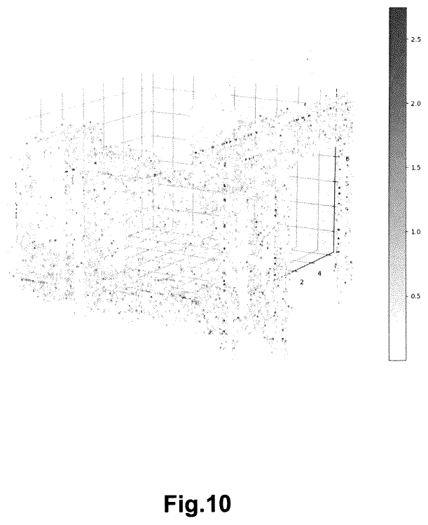

In FIG. 10, a spin map of the simulation from FIG. 9 is shown. The spin changes were filtered using a threshold method, wherein a small threshold value was used. The spin map of FIG. 10 comprises spin changes at locations of most of the edges and spikes of the machine.

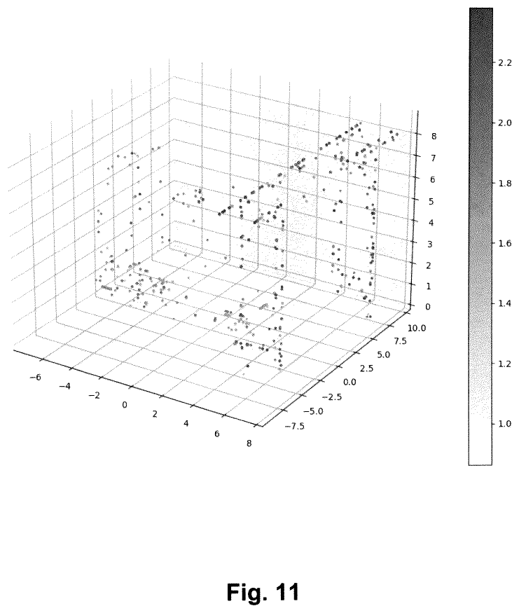

In FIG. 11, a spin map of the simulation from FIG. 9 is shown, wherein the spin changes were previously filtered using a greater threshold value than in FIG. 10. In this way, in the spin map, spin changes are only shown at locations that are located at sharper edges or spikes of the machine.

Based on the filtered spin map, the location of mechanical hazard locations may be determined. By means of the threshold value used for filtering, the sensitivity may be adjusted. The higher the threshold value, the sharper an edge must be to be detected.

The term non-transitory computer-readable medium does not encompass transitory electrical or electromagnetic signals propagating through a medium (such as on a carrier wave). Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The phrase at least one of A, B, and C should be construed to mean a logical (A OR B OR C), using a non-exclusive logical OR, and should not be construed to mean “at least one of A, at least one of B, and at least one of C.” Overall, the present invention is not limited by the examples of implementation presented here, but is defined by the following claims.

What is claimed is:

1. A computer-implemented method for determining a parameter of a safety configuration of a safety system for a machine, the method comprising:
providing a virtual model of the machine in a virtual environment;
simulating a scattering of a set of particles from the virtual model of the machine in the virtual environment, wherein simulation data of the set of particles is acquired during the simulation;
determining spin changes of a subset of particles of the set of particles based on the simulation data, wherein, for each particle of the subset of particles, the spin change is associated with a location of the particle at a time of the spin change;
filtering the determined spin changes according to a set of filter criteria, wherein according to a first filter criterion of the set of filter criteria, filtering is performed for ones of the spin changes that are greater than or equal to a defined threshold value;
determining mechanical hazard locations based on the locations that are associated with the filtered spin changes; and
determining the parameter of the safety configuration based on the determined mechanical hazard locations.

2. The method of claim 1 wherein the set of particles includes at least 1000 particles.

3. The method of claim 1 wherein the set of particles includes at least 10,000 particles.

4. The method of claim 1 wherein the set of particles includes at least 100,000 particles.

5. The method of claim 1 wherein each of the particles has a size of 1 mm to 1000 mm.

6. The method of claim 1 wherein each of the particles has a size of 5 mm to 600 mm.

7. The method of claim 1 wherein each of the particles has a size of 50 mm.

8. The method of claim 1 wherein simulating the scattering includes simultaneously scattering a certain number of the set of particles at the virtual model of the machine.

9. The method of claim 8 wherein the simulating the scattering includes simulating collisions of ones of the set of particles with each other.

10. The method of claim 1 wherein:
the simulating the scattering includes emitting the set of particles inwardly from a sphere; and
the sphere is arranged in the virtual environment so that it surrounds the virtual model of the machine.

11. The method of claim 1 wherein according to a second filter criterion of the set of filter criteria, filtering is performed for ones of the spin changes whose associated locations in the virtual environment are within a defined vicinity of the virtual model.

12. The method of claim 1 wherein:
determining the spin changes includes generating a spin map based on the determined spin changes and the locations associated therewith;
the filtering includes filtering the spin map to create a filtered spin map; and
the mechanical hazard locations of the machine are determined based on the filtered spin map.

13. The method of claim 1 wherein the parameter of the safety configuration includes an arrangement of at least one of:
a protection device of the safety system;
a safety zone around the determined mechanical hazard locations; and
a safety distance from the determined mechanical hazard locations.

14. The method of claim 1 wherein the parameter of the safety configuration is a configuration of at least one of:
a protection device of the safety system;
a safety zone around the determined mechanical hazard locations; and
a safety distance from the determined mechanical hazard locations.

15. A method comprising:
performing the method of claim 1 to determine the parameter of the safety configuration of the safety system for the machine; and
setting up the safety system based on the safety configuration.

16. The method of claim 15 wherein setting up the safety system includes arranging a protection device of the safety system based on the safety configuration.

17. The method of claim 15 wherein setting up the safety system includes setting a configuration of a protection device of the safety system based on the safety configuration.

18. The method of claim 15 wherein setting up the safety system includes setting at least one of a safety zone and a safety distance based on the safety configuration.

19. The method of claim 18 wherein the safety system includes a protection device configured to monitor at least one of the safety zone and the safety distance.

20. A non-transitory computer-readable medium comprising instructions to be executed by at least one processor, the instructions including:
providing a virtual model of a machine in a virtual environment;
simulating a scattering of a set of particles from the virtual model of the machine in the virtual environment, wherein simulation data of the set of particles is acquired during the simulation;
determining spin changes of a subset of particles of the set of particles based on the simulation data, wherein, for each particle of the subset of particles, the spin change is associated with a location of the particle at a time of the spin change;
filtering the determined spin changes according to a set of filter criteria, wherein according to a first filter criterion of the set of filter criteria, filtering is performed for ones of the spin changes that are greater than or equal to a defined threshold value;
determining mechanical hazard locations based on the locations that are associated with the filtered spin changes; and
determining a parameter of a safety configuration of a safety system of the machine based on the determined mechanical hazard locations.
